(19) United States
(12) Patent Application Publication
(10) Pub. No.: US 2020/0056807 A1
(43) Pub. Date: Feb. 20, 2020

(54) Recondensing Refrigerant Vent Gas with Liquefied Natural Gas Boil Off Gas and End Flash Gas

(71) Applicants: Brett L. Ryberg, Dallas, TX (US); Stephen Wright, Georgetown, TX (US); Kenichi Tadano, Yokohama (JP); Naoki Watanabe, Yokohama (JP)

(72) Inventors: Brett L. Ryberg, Dallas, TX (US); Stephen Wright, Georgetown, TX (US); Kenichi Tadano, Yokohama (JP); Naoki Watanabe, Yokohama (JP)

(21) Appl. No.: 16/519,808

(22) Filed: Jul. 23, 2019

Related U.S. Application Data
(60) Provisional application No. 62/718,709, filed on Aug. 14, 2018.

(51) Int. Cl. F24H 1/44; F28F 9/00; F16K 24/02

(52) U.S. Cl. CPC F24H 1/445; F24H 1/52; F16K 24/02; F28F 9/005

(57) ABSTRACT

Liquefied natural gas (LNG) boil off gas (BOG) and/or end flash gas (EFG) can be used to recondense refrigerant vent gas. For example, a method can include: passing LNG BOG through a first condensing heat exchanger and/or passing an EFG from liquefaction system through a second condensing heat exchanger; and condensing the refrigerant vent gas in the first and/or second condensing heat exchangers, wherein (when using the first condensing heat exchanger) the LNG BOG is the coolant in the first condensing heat exchanger and (when using the second condensing heat exchanger) the EFG is the coolant in the second condensing heat exchanger, and wherein (when using both condensing heat exchangers) the first and second condensing heat exchangers are in parallel and not in series.

### CROSS REFERENCE TO RELATED APPLICATION

This application claims the priority benefit of United States Provisional Patent Application No. 62/718,709 filed Aug. 14, 2018, entitled RECONDENSING REFRIGERANT VENT GAS WITH LIQUEFIED NATURAL GAS BOIL OFF GAS AND END FLASH GAS.

### FIELD

This disclosure relates generally to economical use of liquefied natural gas (LNG) boil off gas (BOG) and/or end flash gas (EFG) to recondense refrigerant vent gas.

### BACKGROUND

In a natural gas liquefaction plant, refrigerants like ethane, propane, and butane are used in the process of liquefying natural gas. Accordingly, it is necessary to store quantities of refrigerants at the plant. Typically, refrigerants are stored at near-atmospheric pressure in cooled storage tanks to maintain the refrigerants in the liquid phase. However, some boil off (or evaporation) of the refrigerants is unavoidable, for example, during filling the storage tank and as heat leaks into the tank from the surrounding environment. Reducing the amount of boil off refrigerant (also referred to herein as “refrigerant vent gas”) saves money and reduces emissions to the atmosphere. Mechanical refrigeration packages can be used to mitigate refrigerant vent gas production. However, these refrigeration systems can be costly and significantly increase the footprint of the storage tank. Additionally, the refrigeration systems can be complicated and require operational surveillance and maintenance.

Other, less costly and easier to maintain, systems would be useful in a natural gas liquefaction plant.

### SUMMARY

This disclosure relates generally to economical use of LNG BOG and/or EFG to recondense refrigerant vent gas.

A system can comprise: a refrigerant storage tank vent line fluidly connecting a refrigerant storage tank to a condensing heat exchanger to supply a refrigerant vent gas from the refrigerant storage tank to the condensing heat exchanger; a condensed refrigerant line fluidly connecting the condensing heat exchanger to the refrigerant storage tank to supply a condensed refrigerant from the condensing heat exchanger to the refrigerant storage tank; a liquefied natural gas (LNG) boil off gas (BOG) header fluidly connecting an LNG storage tank to a low-head compressor to supply an LNG BOG from the LNG storage tank to the low-head compressor; a first line fluidly connecting the low-head compressor to the condensing heat exchanger to supply the LNG BOG from the low-head compressor to the condensing heat exchanger, wherein the LNG BOG and the refrigerant vent gas do not contact in the condensing heat exchanger, and wherein the LNG BOG acts as a coolant in the condensing heat exchanger; and a second line fluidly connecting the condensing heat exchanger to an LNG BOG compressor to supply the LNG BOG from the condensing heat exchanger to the LNG BOG compressor. Optionally, such a system can be configured wherein the condensing heat exchanger is a first condensing heat exchanger and the low-head compressor is a first low-head compressor, wherein the refrigerant storage tank vent line fluidly connects the refrigerant storage tank to a second condensing heat exchanger, and wherein the system further comprises: a seventh line fluidly connecting a liquefaction system to a second low-head compressor to supply an end flash gas (EFG) from the liquefaction system to the second low-head compressor; an eighth line fluidly connecting the second low-head compressor to a second condensing heat exchanger to supply the EFG from the second low-head compressor to the second condensing heat exchanger, wherein the EFG and the refrigerant vent gas do not contact in the second condensing heat exchanger, and wherein the EFG acts as a coolant in the second condensing heat exchanger; and a ninth line fluidly connecting the second condensing heat exchanger to the refrigerant storage tank to supply condensed refrigerant from the second condensing heat exchanger to the refrigerant storage tank, wherein the first and second condensing heat exchangers are in parallel and not in series.

A method can comprise: passing liquefied natural gas (LNG) boil off gas (BOG) through a condensing heat exchanger; and condensing a refrigerant vent gas in the condensing heat exchanger, wherein the LNG BOG is the coolant in the condensing heat exchanger. Optionally, the method, wherein the condensing heat exchanger is a first condensing heat exchanger, can further comprise: passing an EFG from liquefaction system through a second condensing heat exchanger; and condensing a portion of the refrigerant vent gas in the second condensing heat exchanger, wherein the EFG is the coolant in the condensing heat exchanger, wherein the first and second condensing heat exchangers are in parallel and not in series.

A system can comprise: a refrigerant storage tank vent line fluidly connecting a refrigerant storage tank to a condensing heat exchanger to supply a refrigerant vent gas from the refrigerant storage tank to the condensing heat exchanger; a condensed refrigerant line fluidly connecting the condensing heat exchanger to the refrigerant storage tank to supply a condensed refrigerant from the condensing heat exchanger to the refrigerant storage tank; a first line fluidly connecting a liquefaction system to a low-head compressor to supply EFG from the liquefaction system to the low-head compressor; and a second line fluidly connecting the low-head compressor to a condensing heat exchanger to supply the EFG from the low-head compressor to the condensing heat exchanger, wherein the EFG and the refrigerant vent gas do not contact in the condensing heat exchanger, and wherein the EFG acts as a coolant in the condensing heat exchanger.

A method can comprise: passing an EFG from a liquefaction system through a condensing heat exchanger; and condensing the refrigerant vent gas in the condensing heat exchangers, wherein the EFG is the coolant in the condensing heat exchanger.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is an illustrative diagram of a portion of a natural gas liquefaction plant where

LNG BOG is used to condense refrigerant vent gas.

FIG. 2 is another illustrative diagram of a portion of a natural gas liquefaction plant where LNG BOG and EFG are used to condense refrigerant vent gas.

FIG. 3 is another illustrative diagram of a portion of a natural gas liquefaction plant where EFG is used to condense refrigerant vent gas.

### DETAILED DESCRIPTION

This disclosure relates generally to economical use of LNG BOG and/or EFG to recondense refrigerant vent gas. More specifically, LNG BOG and/or EFG are used as the coolant in a condenser to condense refrigerant vent gas back into liquid refrigerant, which maintains the supply of refrigerant at the plant and mitigates refrigerant emissions.

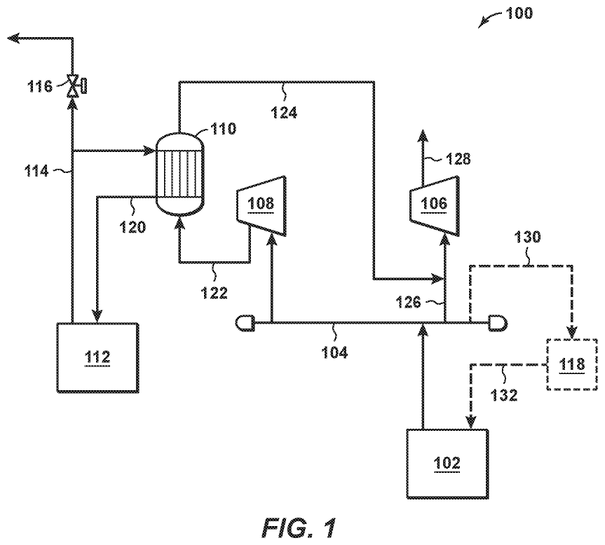

FIG. 1 is an illustrative diagram of a portion 100 of a natural gas liquefaction plant where LNG BOG is used to condense refrigerant vent gas. LNG in the LNG storage tank 102 vaporizes to LNG BOG over time due at least in part to heat from the surrounding environment warming the LNG. In the illustrative diagram, the LNG BOG is captured in an LNG BOG header 104 that fluidly couples the LNG storage tank 102 to an LNG BOG compressor 106 and a low-head compressor 108. The LNG BOG in the LNG BOG header 104 is at substantially ambient pressure. As used herein, “substantially ambient pressure” refers to ambient pressure ±5 bar absolute (bara).

As used herein, when describing a line or other component that fluidly connects other components, the line is used as a general term to encompass the line or lines that fluidly connect the components and the other hardware like pumps, connectors, heat exchangers, and valves that may be installed along the line.

When the LNG BOG from the LNG BOG header 104 passes through the LNG BOG compressor 106, the LNG BOG is compressed to a pressure of about 50 bara to about 70 bara (about 1,015 psia) and sent to a fuel gas subsystem through line 128. The fuel gas subsystem provides fuel gas to various components of the natural gas liquefaction plant.

By contrast, when the LNG BOG from the LNG BOG header 104 passes through the low-head compressor 108, the low-head compressor 108 compresses the LNG BOG to a pressure of less than about 10 bara. The low-head compressor 108 is designed not necessarily to compress the LNG BOG from the header, but rather to distribute the LNG BOG to the condensing heat exchanger 110. The LNG BOG flows through the condensing heat exchanger 110 as the coolant gas and returns back to the LNG BOG header 104.

Optionally, the LNG BOG from the LNG BOG header 104 can be recondensed through a liquefaction compressor 118 and returned to the LNG storage tank 102.

Refrigerant in a refrigerant storage tank 112, much like the LNG in the LNG storage tank, evaporates to produce a refrigerant vent gas. The refrigerant vent gas is transported to the condensing heat exchanger 110 via a refrigerant vent line 114. The refrigerant vent line 114 includes in parallel with the condensing heat exchanger 110 a pressure control valve 116 that allow the refrigerant vent gas to be vented to flare if too much pressure builds up in the refrigerant vent line 114.

By way of a brief summary of FIG. 1, a system can include a refrigerant storage tank vent line 114 fluidly connecting a refrigerant storage tank 112 to a condensing heat exchanger 110 to supply a refrigerant vent gas from the refrigerant storage tank 112 to the condensing heat exchanger 110; a condensed refrigerant line 120 fluidly connecting the condensing heat exchanger 110 to the refrigerant storage tank 112 to supply a condensed refrigerant from the condensing heat exchanger 110 to the refrigerant storage tank 112; an LNG BOG header 104 fluidly connecting an LNG storage tank 102 to a low-head compressor 108 to supply an LNG BOG from the LNG storage tank 102 to the low-head compressor 108; a line 122 fluidly connecting the low-head compressor 108 to the condensing heat exchanger 110 to supply the LNG BOG from the low-head compressor 108 to the condensing heat exchanger 110, wherein the LNG BOG and the refrigerant vent gas do not contact in the condensing heat exchanger 110, and wherein the LNG BOG acts as a coolant in the condensing heat exchanger 110; and a line 124 fluidly connecting the condensing heat exchanger 110 to an LNG BOG compressor 106 to supply the LNG BOG from the condensing heat exchanger 110 to the LNG BOG compressor 106 (or an associated supply line 126). Further, the system can further include a line 126 fluidly connecting the LNG BOG header 104 to an LNG BOG compressor 106 to supply the LNG BOG from the LNG BOG header 104 to the LNG BOG compressor 106; and a line 128 fluidly connecting the LNG BOG compressor 106 to a fuel gas subsystem to supply compressed LNG BOG from the LNG BOG compressor 106 to the fuel gas subsystem. The system (with or without the LNG BOG compressor 106 and related lines 126, 128) can further include: a line 130 fluidly connecting the LNG BOG header 104 to a liquefaction compressor 118 to supply the LNG BOG from the LNG BOG header 104 to the liquefaction compressor 118; and a line 132 fluidly connecting the liquefaction compressor 118 to the LNG storage tank 102 to supply an LNG from the liquefaction compressor 118 to the LNG storage tank 102.

Further, a method illustrated in FIG. 1 can include: passing LNG BOG through a condensing heat exchanger 110; and condensing refrigerant vent gas in the condensing heat exchanger 110, wherein the LNG BOG is the coolant in the condensing heat exchanger 110.

Further, the method can include: compressing the LNG BOG with a low-head pressure compressor 108 before passing of the LNG BOG through the condensing heat exchanger 110. Further, the method can include: condensing the LNG BOG to produce compressed LNG BOG in parallel with the passing of the LNG BOG through the condensing heat exchanger; and supplying the compressed LNG BOG to a fuel gas subsystem. Further, the method can include:

condensing the LNG BOG to produce LNG in parallel with the passing of the LNG BOG through the condensing heat exchanger 110; and supply the LNG to an LNG storage tank 102.

The illustrated portion 100 of a natural gas liquefaction plant uses the LNG BOG to condense the refrigerant vent gas, which reduces the loss of refrigerant vent gas and uses simple equipment that is less bulky and with reduced maintenance requirements than a mechanical refrigeration system.

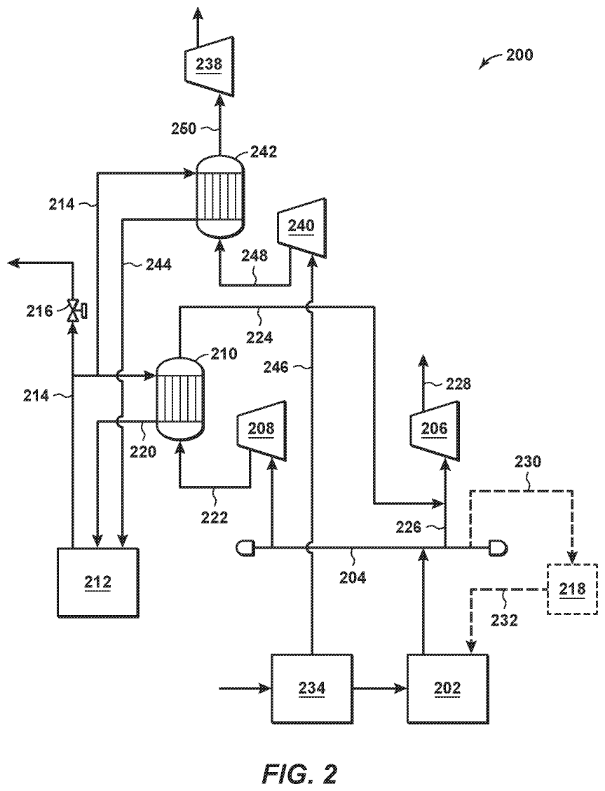

FIG. 2, with continued reference to FIG. 1, is another illustrative diagram of a portion 200 of a natural gas liquefaction plant where LNG BOG and end flash gas (EFG) are used to condense refrigerant vent gas. In this example, the LNG BOG from the tank 202 is processed as described in FIG. 1 as a coolant in the first condensing heat exchanger 210 to condense the refrigeration vent gas. In addition, EFG from a liquefaction system 234 is used as coolant in a second condensing heat exchanger 242 to condense the refrigeration vent gas. Examples of liquefaction systems include, but are not limited to, those described in U.S. Pat. Nos. 5,916,260 and 6,658,892, U. S. Patent Application No. 2007/0193303 and PCT International Application No. WO2011/109117, each of which is incorporated herein by reference.

In this example, the process of liquefying the natural gas uses the liquefaction system 234 to reduce the pressure of the feed gas. The feed gas is natural gas having undergone the necessary treatments to be suitable for liquefaction. The treatments depend on the composition of the natural gas (e.g., sulfur, water, and mercury content) and can include, but are not limited to, condensate removal, acid gas removal, dehydration, mercury removal, heavy-hydrocarbon removal, and combinations thereof. The feed gas is typically at about 55 bara (about 798 psi absolute (psia)) to about 70 bara (about 1,015 psia) and is reduced to substantially ambient pressure. In the process, some of the gas flashes and becomes vapor known as EFG. Typically, the flashing process preferentially flashes off contaminants such as nitrogen and thus at least partially purifies the remaining liquid and leaves the EFG containing the majority of the contaminants.

In a typical plant setup, the EFG is compressed and used as fuel gas. In this example, however, before compressing the EFG with an EFG compressor 238 for use as fuel gas in the plant, the EFG passes through a second low-head compressor 240 that transports the EFG to the second condensing heat exchanger 242. The second condensing heat exchanger 242 provides additional condensing capacity for the refrigerant vent gas from refrigerant vent line 214.

Optionally, additional components can be included in the portion 200 of the natural gas liquefaction plant like valves and additional lines that allows for system controls like: controlling the amount of refrigerant vent gas from refrigerant vent line 214 that is distributed to the first and second condensing heat exchangers 210, 242; and controlling which of (or if both of) the first and second condensing heat exchangers 210, 242 are in operation or bypassed by the LNG BOG and EFG, respectively.

By way of a brief summary of FIG. 2, a system can include a refrigerant storage tank vent line 214 fluidly connecting a refrigerant storage tank 212 to a first condensing heat exchanger 210 and a second condensing heat exchanger 242 to supply a refrigerant vent gas from the refrigerant storage tank 212 to the first and second condensing heat exchangers 210, 242, wherein the first and second condensing heat exchangers 210, 242 are in parallel, not series; a first condensed refrigerant line 220 fluidly connecting the first condensing heat exchanger 210 to the refrigerant storage tank 212 to supply condensed refrigerant from the first condensing heat exchanger 210 to the refrigerant storage tank 212; a second condensed refrigerant line 244 fluidly connecting the second condensing heat exchanger 242 to the refrigerant storage tank 212 to supply a condensed refrigerant from the second condensing heat exchanger 242 to the refrigerant storage tank 212; an LNG BOG header 204 fluidly connecting an LNG storage tank 202 to a first low-head compressor 208 to supply an LNG BOG from the LNG storage tank 202 to the first low-head compressor 208; a line 222 fluidly connecting the first low-head compressor 208 to the first condensing heat exchanger 210 to supply the LNG BOG from the first low-head compressor 208 to the first condensing heat exchanger 210, wherein the LNG BOG and the refrigerant vent gas do not contact in the first condensing heat exchanger 210, and wherein the LNG BOG acts as a coolant in the first condensing heat exchanger 210; a line 224 fluidly connecting the first condensing heat exchanger 210 to an LNG BOG compressor 206 to supply the LNG BOG from the first condensing heat exchanger 210 to the LNG BOG compressor 206 (or an associated supply line 226); a line 246 fluidly connecting a liquefaction system 234 to a second low-head compressor 240 to supply EFG from the liquefaction system 234 to the second low-head compressor 240; and a line 248 fluidly connecting the second low-head compressor 240 to a second condensing heat exchanger 242 to supply the EFG from the second low-head compressor 240 to the second condensing heat exchanger 242, wherein the EFG and the refrigerant vent gas do not contact in the second condensing heat exchanger 242, and wherein the EFG acts as a coolant in the second condensing heat exchanger 242. Further, the system can include a line 250 that supplies EFG from the second condensing heat exchanger 242 to an EFG compressor 238 that then supplies compressed EFG to a fuel gas subsystem. Further, the system can further include a line 226 fluidly connecting the LNG BOG header 204 to an LNG BOG compressor 206 to supply the LNG BOG from the LNG BOG header 204 to the LNG BOG compressor 206; and a line 228 fluidly connecting the LNG BOG compressor 206 to the fuel gas subsystem to supply compressed LNG BOG from the LNG BOG compressor 206 to the fuel gas subsystem. The system (with or without the LNG BOG compressor 206 and related lines 226, 228) can further include: a line 230 fluidly connecting the LNG BOG header 204 to a liquefaction compressor 218 to supply the LNG BOG from the LNG BOG header 204 to the liquefaction compressor 218; and a line 232 fluidly connecting the liquefaction compressor 218 to the LNG storage tank 202 to supply an LNG from the liquefaction compressor 218 to the LNG storage tank 202. The refrigerant vent line 214 can also include in parallel with the first and second condensing heat exchangers 210, 242 a pressure control valve 216 that allow the refrigerant vent gas to be vented to flare if too much pressure builds up in the refrigerant vent line 214.

A method corresponding to FIG. 2 can include: passing LNG BOG through a first condensing heat exchanger 210; passing an EFG from liquefaction system 234 through a second condensing heat exchanger 242; and condensing the refrigerant vent gas in the first and second condensing heat exchangers, wherein the LNG BOG is the coolant in the first condensing heat exchanger and the EFG is the coolant in the second condensing heat exchanger, and wherein the first and second condensing heat exchangers are in parallel and not in series.

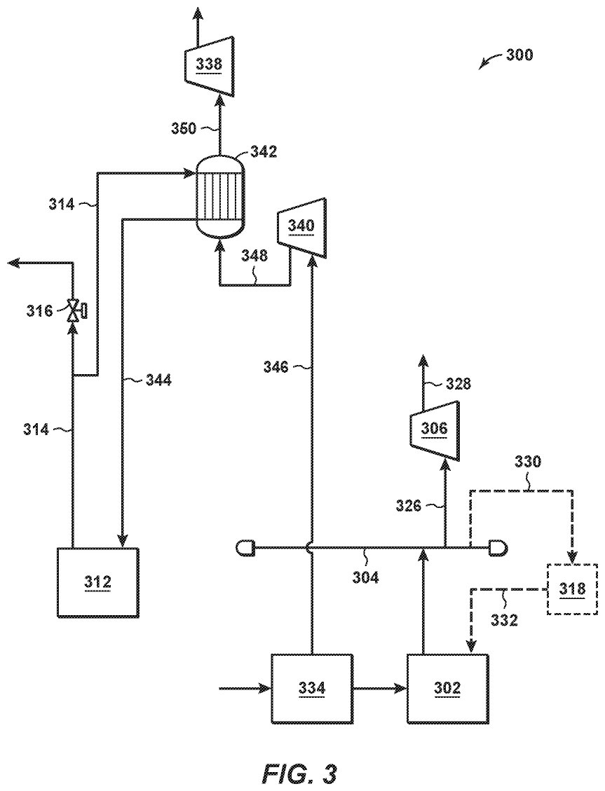

FIG. 3, with continued reference to FIGS. 1 and 2, is another illustrative diagram of a portion 300 of a natural gas liquefaction plant where EFG is used to recondense refrigerant vent gas. In this example, EFG from liquefaction system 234 is processed as described in FIG. 2 as a coolant in the condensing heat exchanger 342 to condense the refrigeration vent gas. Examples of liquefaction systems include, but are not limited to, those described in U.S. Pat. Nos. 5,916,260 and 6,658,892, U. S. Patent Application No. 2007/0193303 and PCT International Application No. WO2011/109117, each of which is incorporated herein by reference.

In this example, the process of liquefying the natural gas uses the liquefaction system 334 to reduce the pressure of the feed gas. The feed gas is natural gas having undergone the necessary treatments to be suitable for liquefaction. The treatments depend on the composition of the natural gas (e.g., sulfur, water, and mercury content) and can include, but are not limited to, condensate removal, acid gas removal, dehydration, mercury removal, heavy-hydrocarbon removal, and combinations thereof. The feed gas is typically at about 55 bara (about 798 psi absolute (psia)) to about 70 bara (about 1,015 psia) and is reduced to substantially ambient pressure. In the process, some of the gas flashes and becomes vapor known as EFG. Typically, the flashing process preferentially flashes off contaminants such as nitrogen and thus at least partially purifies the remaining liquid and leaves the EFG containing the majority of the contaminants.

In a typical plant setup, the EFG is compressed and used as fuel gas. In this example, however, before compressing the EFG with an EFG compressor 338 for use as fuel gas in the plant, the EFG passes through a low-head compressor 340 that transports the EFG to the condensing heat exchanger 342. The condensing heat exchanger 342 provides additional condensing capacity for the refrigerant vent gas from refrigerant vent line 314. The refrigerant vent line 314 can also include a pressure control valve 316 that allows the refrigerant vent gas to be vented to flare if too much pressure builds up in the refrigerant vent line 314.

Optionally, additional components can be included in the portion 300 of the natural gas liquefaction plant like valves and additional lines that allows for system controls like: controlling the amount of refrigerant vent gas from refrigerant vent line 314 that is distributed to the condensing heat exchangers 342; and controlling which of (or if both of) the condensing heat exchangers 342 are in operation or bypassed by the LNG BOG and EFG, respectively.

By way of a brief summary of FIG. 3, a system can include a refrigerant storage tank vent line 314 fluidly connecting a refrigerant storage tank 312 to a condensing heat exchanger 342 to supply a refrigerant vent gas from the refrigerant storage tank 312 to the condensing heat exchangers 342; a condensed refrigerant line 344 fluidly connecting the condensing heat exchanger 342 to the refrigerant storage tank 312 to supply a condensed refrigerant from the condensing heat exchanger 342 to the refrigerant storage tank 312; a line 346 fluidly connecting a liquefaction system 334 to a low-head compressor 340 to supply EFG from the liquefaction system 334 to the low-head compressor 340; and a line 348 fluidly connecting the low-head compressor 340 to a condensing heat exchanger 342 to supply the EFG from the low-head compressor 340 to the condensing heat exchanger 342, wherein the EFG and the refrigerant vent gas do not contact in the condensing heat exchanger 342, and wherein the EFG acts as a coolant in the condensing heat exchanger 342. Further, the system can include a line 350 that supplies EFG from the condensing heat exchanger 342 to an EFG compressor 338 that then supplies compressed EFG to a fuel gas subsystem. Further, the system can include an LNG BOG header 304 fluidly connected to an LNG storage tank 302; a line 326 fluidly connecting the LNG BOG header 304 to an LNG BOG compressor 306 to supply the LNG BOG from the LNG BOG header 304 to the LNG BOG compressor 306; and a line 328 fluidly connecting the LNG BOG compressor 306 to the fuel gas subsystem to supply compressed LNG BOG from the LNG BOG compressor 306 to the fuel gas subsystem. The system (with or without the LNG BOG compressor 306 and related lines 326, 328) can further include: a line 330 fluidly connecting the LNG BOG header 304 to a liquefaction compressor 318 to supply the LNG BOG from the LNG BOG header 304 to the liquefaction compressor 318; and a line 332 fluidly connecting the liquefaction compressor 318 to the LNG storage tank 302 to supply an LNG from the liquefaction compressor 318 to the LNG storage tank 302.

A method corresponding to FIG. 3 can include: passing an EFG from a liquefaction system 334 through a condensing heat exchanger 342; and condensing the refrigerant vent gas in the condensing heat exchangers, wherein the EFG is the coolant in the condensing heat exchanger.

### EXAMPLES

Example 1 is a system comprising: a refrigerant storage tank vent line fluidly connecting a refrigerant storage tank to a condensing heat exchanger to supply a refrigerant vent gas from the refrigerant storage tank to the condensing heat exchanger; a condensed refrigerant line fluidly connecting the condensing heat exchanger to the refrigerant storage tank to supply a condensed refrigerant from the condensing heat exchanger to the refrigerant storage tank; a liquefied natural gas (LNG) boil off gas (BOG) header fluidly connecting an LNG storage tank to a low-head compressor to supply an LNG BOG from the LNG storage tank to the low-head compressor; a first line fluidly connecting the low-head compressor to the condensing heat exchanger to supply the LNG BOG from the low-head compressor to the condensing heat exchanger, wherein the LNG BOG and the refrigerant vent gas do not contact in the condensing heat exchanger, and wherein the LNG BOG acts as a coolant in the condensing heat exchanger; and a second line fluidly connecting the condensing heat exchanger to an LNG BOG compressor to supply the LNG BOG from the condensing heat exchanger to the LNG BOG compressor.

### Example 2

The system of Example 1 further comprising: a third line fluidly connecting the LNG BOG header to an LNG BOG compressor to supply the LNG BOG from the LNG BOG header to the LNG BOG compressor; and a fourth line fluidly connecting the LNG BOG compressor to a fuel gas subsystem to supply compressed LNG BOG from the LNG BOG compressor to the fuel gas subsystem.

### Example 3

The system of Example 1 and/or 2 further comprising: a fifth line fluidly connecting the LNG BOG header to a liquefaction compressor to supply the LNG BOG from the LNG BOG header to the liquefaction compressor; and

a sixth line fluidly connecting the liquefaction compressor to the LNG storage tank to supply an LNG from the liquefaction compressor to the LNG storage tank.

### Example 4

The system of one or more of Examples 1-3 further comprising: a pressure control valve coupled to the refrigerant storage tank vent line.

### Example 5

The system of one or more of Examples 1-4 wherein the LNG BOG in the LNG BOG header, the first line, and the second line individually is at about 1 bara to about 2 bara.

### Example 6

The system of one or more of Examples 1-5 wherein the condensing heat exchanger is a first condensing heat exchanger and the low-head compressor is a first low-head compressor, wherein the refrigerant storage tank vent line fluidly connects the refrigerant storage tank to a second condensing heat exchanger, and wherein the system further comprises: a seventh line fluidly connecting a liquefaction system to a second low-head compressor to supply an end flash gas (EFG) from the liquefaction system to the second low-head compressor; an eighth line fluidly connecting the second low-head compressor to a second condensing heat exchanger to supply the EFG from the second low-head compressor to the second condensing heat exchanger, wherein the EFG and the refrigerant vent gas do not contact in the second condensing heat exchanger, and wherein the EFG acts as a coolant in the second condensing heat exchanger; and a ninth line fluidly connecting the second condensing heat exchanger to the refrigerant storage tank to supply condensed refrigerant from the second condensing heat exchanger to the refrigerant storage tank, wherein the first and second condensing heat exchangers are in parallel and not in series.

### Example 7

The system of Example 6 further comprising: a tenth line fluidly connecting the second condensing heat exchanger to a EFG compressor to supply the EFG from the second condensing heat exchanger to the EFG compressor; and an eleventh line fluidly connecting the EFG compressor to the fuel gas subsystem to supply compressed EFG from the EFG compressor to the fuel gas subsystem.

Example 8 is a method comprising: passing liquefied natural gas (LNG) boil off gas (BOG) through a condensing heat exchanger; and condensing a refrigerant vent gas in the condensing heat exchanger, wherein the LNG BOG is the coolant in the condensing heat exchanger.

### Example 9

The method of Example 8 further comprising: compressing the LNG

BOG with a low-head pressure compressor before passing of the LNG BOG through the condensing heat exchanger.

### Example 10

The method of Example 8 and/or 9 further comprising: condensing the LNG BOG to produce compressed LNG BOG in parallel with the passing of the LNG BOG through the condensing heat exchanger; and supplying the compressed LNG BOG to a fuel gas subsystem.

### Example 11

The method of one or more of Examples 9-10 further comprising: condensing the LNG BOG to produce LNG in parallel with the passing of the LNG BOG through the condensing heat exchanger; and supplying the LNG to an LNG storage tank.

### Example 12

The method of one or more of Examples 9-11 wherein the LNG BOG in the condensing heat exchanger is at about 1 bara to about 2 bara.

### Example 13

The method of one or more of Examples 9-12 wherein the condensing heat exchanger is a first condensing heat exchanger, and wherein the method further comprises: passing an EFG from liquefaction system through a second condensing heat exchanger; and condensing a portion of the refrigerant vent gas in the second condensing heat exchanger, wherein the EFG is the coolant in the condensing heat exchanger, wherein the first and second condensing heat exchangers are in parallel and not in series.

### Example 14

The method of one or more of Example 13 further comprising: compressing the EFG after passing of the EFG through the second condensing heat exchanger; and supplying the compressed EFG to the fuel gas subsystem.

Example 15 is a system comprising: a refrigerant storage tank vent line fluidly connecting a refrigerant storage tank to a condensing heat exchanger to supply a refrigerant vent gas from the refrigerant storage tank to the condensing heat exchanger; a condensed refrigerant line fluidly connecting the condensing heat exchanger to the refrigerant storage tank to supply a condensed refrigerant from the condensing heat exchanger to the refrigerant storage tank; a first line fluidly connecting a liquefaction system to a low-head compressor to supply EFG from the liquefaction system to the low-head compressor; and a second line fluidly connecting the low-head compressor to a condensing heat exchanger to supply the EFG from the low-head compressor to the condensing heat exchanger, wherein the EFG and the refrigerant vent gas do not contact in the condensing heat exchanger, and wherein the EFG acts as a coolant in the condensing heat exchanger.

### Example 16

The system of Example 15 further comprising: an LNG BOG header fluidly connected to an LNG storage tank; a third line fluidly connecting the LNG BOG header to an LNG BOG compressor to supply the LNG BOG from the LNG BOG header to the LNG BOG compressor; and a fourth line fluidly connecting the LNG BOG compressor to the fuel gas subsystem to supply compressed LNG BOG from the LNG BOG compressor to the fuel gas subsystem.

### Example 17

The system of Example 15 or 16 17 further comprising: a fifth line fluidly connecting the LNG BOG header to a liquefaction compressor to supply the LNG BOG from the LNG BOG header to the liquefaction compressor; and a sixth line fluidly connecting the liquefaction compressor to the LNG storage tank to supply an LNG from the liquefaction compressor to the LNG storage tank.

Example 18 is a method comprising: passing an EFG from a liquefaction system through a condensing heat exchanger; and condensing the refrigerant vent gas in the condensing heat exchangers, wherein the EFG is the coolant in the condensing heat exchanger.

### Example 19

The method of Example 18 further comprising: compressing the EFG after passing of the EFG through the condensing heat exchanger; and supplying the compressed EFG to the fuel gas subsystem.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A system comprising:
a refrigerant storage tank vent line fluidly connecting a refrigerant storage tank to a condensing heat exchanger to supply a refrigerant vent gas from the refrigerant storage tank to the condensing heat exchanger;
a condensed refrigerant line fluidly connecting the condensing heat exchanger to the refrigerant storage tank to supply a condensed refrigerant from the condensing heat exchanger to the refrigerant storage tank;
a liquefied natural gas (LNG) boil off gas (BOG) header fluidly connecting an LNG storage tank to a low-head compressor to supply an LNG BOG from the LNG storage tank to the low-head compressor;
a first line fluidly connecting the low-head compressor to the condensing heat exchanger to supply the LNG BOG from the low-head compressor to the condensing heat exchanger, wherein the LNG BOG and the refrigerant vent gas do not contact in the condensing heat exchanger, and wherein the LNG BOG acts as a coolant in the condensing heat exchanger; and
a second line fluidly connecting the condensing heat exchanger to an LNG BOG compressor to supply the LNG BOG from the condensing heat exchanger to the LNG BOG compressor.

2. The system of claim 1, further comprising:
a third line fluidly connecting the LNG BOG header to the LNG BOG compressor to supply the LNG BOG from the LNG BOG header to the LNG BOG compressor; and
a fourth line fluidly connecting the LNG BOG compressor to a fuel gas subsystem to supply compressed LNG BOG from the LNG BOG compressor to the fuel gas subsystem.

3. The system of claim 1, further comprising:
a fifth line fluidly connecting the LNG BOG header to a liquefaction compressor to supply the LNG BOG from the LNG BOG header to the liquefaction compressor; and
a sixth line fluidly connecting the liquefaction compressor to the LNG storage tank to supply an LNG from the liquefaction compressor to the LNG storage tank.

4. The system of claim 1, further comprising:
a pressure control valve coupled to the refrigerant storage tank vent line.

5. The system of claim 1, wherein the LNG BOG in the LNG BOG header, the first line, and the second line individually are at about 1 bar absolute (bara) to about 2 bara.

6. The system of claim 1, wherein the condensing heat exchanger is a first condensing heat exchanger and the low-head compressor is a first low-head compressor, wherein the refrigerant storage tank vent line fluidly connects the refrigerant storage tank to a second condensing heat exchanger, and wherein the system further comprises:
a seventh line fluidly connecting a liquefaction system to a second low-head compressor to supply an end flash gas (EFG) from the liquefaction system to the second low-head compressor;
an eighth line fluidly connecting the second low-head compressor to the second condensing heat exchanger to supply the EFG from the second low-head compressor to the second condensing heat exchanger, wherein the EFG and the refrigerant vent gas do not contact in the second condensing heat exchanger, and wherein the EFG acts as a coolant in the second condensing heat exchanger; and
a ninth line fluidly connecting the second condensing heat exchanger to the refrigerant storage tank to supply condensed refrigerant from the second condensing heat exchanger to the refrigerant storage tank, wherein the first and second condensing heat exchangers are in parallel and not in series.

7. The system of claim 6, further comprising:
a tenth line fluidly connecting the second condensing heat exchanger to a EFG compressor to supply the EFG from the second condensing heat exchanger to the EFG compressor; and
an eleventh line fluidly connecting the EFG compressor to the fuel gas subsystem to supply compressed EFG from the EFG compressor to the fuel gas subsystem.

8. A method comprising:
passing liquefied natural gas (LNG) boil off gas (BOG) through a condensing heat exchanger; and
condensing a refrigerant vent gas in the condensing heat exchanger, wherein the LNG BOG is a coolant in the condensing heat exchanger.

9. The method of claim 8, further comprising:
compressing the LNG BOG with a low-head pressure compressor before passing of the LNG BOG through the condensing heat exchanger.

10. The method of claim 8, further comprising:
condensing the LNG BOG to produce compressed LNG BOG in parallel with the passing of the LNG BOG through the condensing heat exchanger; and
supplying the compressed LNG BOG to a fuel gas subsystem.

11. The method of claim 8, further comprising:
condensing the LNG BOG to produce LNG in parallel with the passing of the LNG BOG through the condensing heat exchanger; and
supplying the LNG to an LNG storage tank.

12. The method of claim 8, wherein the LNG BOG in the condensing heat exchanger is at about 1 bara to about 2 bara.

13. The method of claim 8, wherein condensing heat exchanger is a first condensing heat exchanger, and wherein the method further comprises:
passing an end flash gas (EFG) from a liquefaction system through a second condensing heat exchanger; and
condensing a portion of the refrigerant vent gas in the second condensing heat exchanger, wherein the EFG is a coolant in the second condensing heat exchanger, and wherein the first and second condensing heat exchangers are in parallel and not in series.

14. The method of claim 13, further comprising:
compressing the EFG after passing of the EFG through the second condensing heat exchanger; and
supplying the compressed EFG to the fuel gas subsystem.

15. A system comprising:
a refrigerant storage tank vent line fluidly connecting a refrigerant storage tank to a condensing heat exchanger to supply a refrigerant vent gas from the refrigerant storage tank to the condensing heat exchanger;
a condensed refrigerant line fluidly connecting the condensing heat exchanger to the refrigerant storage tank to supply a condensed refrigerant from the condensing heat exchanger to the refrigerant storage tank;
a first line fluidly connecting a liquefaction system to a low-head compressor to supply end flash gas (EFG) from the liquefaction system to the low-head compressor; and
a second line fluidly connecting the low-head compressor to a condensing heat exchanger to supply the EFG from the low-head compressor to the condensing heat exchanger, wherein the EFG and the refrigerant vent gas do not contact in the condensing heat exchanger, and wherein the EFG acts as a coolant in the condensing heat exchanger.

16. The system of claim 15, further comprising:
a liquefied natural gas (LNG) boil off gas (BOG) header fluidly connected to an LNG storage tank;
a third line fluidly connecting the LNG BOG header to an LNG BOG compressor to supply the LNG BOG from the LNG BOG header to the LNG BOG compressor; and
a fourth line fluidly connecting the LNG BOG compressor to the fuel gas subsystem to supply compressed LNG BOG from the LNG BOG compressor to the fuel gas subsystem.

17. The system of claim 15, further comprising:
a fifth line fluidly connecting the LNG BOG header to a liquefaction compressor to supply the LNG BOG from the LNG BOG header to the liquefaction compressor; and
a sixth line fluidly connecting the liquefaction compressor to the LNG storage tank to supply an LNG from the liquefaction compressor to the LNG storage tank.
